(19) United States
(12) Patent Application Publication
(10) Pub. No.: US 2026/0212300 A1
(43) Pub. Date: Jul. 23, 2026

(54) METHOD AND SYSTEM FOR GENERATING LOCATION RECOMMENDATIONS

(71) Applicant: Accenture Global Solutions Limited, Dublin (IE)

(72) Inventors: Nitu NIVEDITA, Atlanta, GA (US); Sally LIN, Long Island City, NY (US); Shubhangi MEHROTRA, Gurgaon (IN); Vaishangi BAJPAI, Noida (IN); Vinothini MADASAMY, Sivagangai (IN); Almore Joseph CATO II, New Orleans, LA (US); Nithyashree DASEGOWDA, Bangalore (IN)

(73) Assignee: Accenture Global Solutions Limited, Dublin (IE)

(21) Appl. No.: 19/033,745

(22) Filed: Jan. 22, 2025

(51) Int. Cl. G06Q 10/0637

(52) U.S. Cl. CPC G06Q 10/0637

(57) ABSTRACT

Method, system, and computer-readable storage media for generating location recommendations are disclosed. Data from different data sources is acquired and preprocessed to generate an output. The output includes sub-variables corresponding to each variable and each variable corresponds with a job requirement. A respective score for each sub-variable is computed. Based upon a respective weight and the respective score for each sub-variable, an aggregate variable score for each variable is generated. Based upon the aggregate variable score and a respective weight corresponding to each variable, a respective location index for each location of multiple locations for a job is computed according to the job requirement. Further, each location along with the respective location index is displayed. The respective location index identifies a proposed recommendation for each location of the multiple locations.

### TECHNICAL FIELD

Various examples described herein relate generally to method, system, and computer program product for generating location recommendations.

### BACKGROUND

In general, multiple organizations have been geographically distributed across multiple locations in different geographical areas (e.g., states, countries, contingents, and/or the like). Therefore, determining appropriate locations for jobs or workplaces or offices for such organizations that are geographically distributed makes selecting one location over another a significant and strategic decision that affects operational performance and revenue growth of the organizations, attracts right talent, and identifies suitable demographics for creation of the jobs.

### SUMMARY

Implementations of the present disclosure provide a multi-faceted rule-based framework to generate a location recommendation for a job created by an entity (e.g., an organization). The location recommendation may include one or more locations recommended for the job and a location index for each of the one or more locations. The location index may be computed for each of the one or more locations by considering a myriad of job constraints, location constraints, and logistical considerations, and indicates a preference of a location over other locations.

In at least one example, the present disclosure provides a computer-implemented method for generating location recommendations. The method includes acquiring data from a plurality of data sources. The data is related to an employment associated field. The method includes preprocessing the data to generate an output. The output includes one or more sub-variables corresponding to each variable of a plurality of variables and each variable of the plurality of variables corresponds with a job requirement. The method includes computing a respective score for each sub-variable of the one or more sub-variables corresponding to each variable of the plurality of variables. Based upon a respective weight and the respective score for each sub-variable corresponding to each variable of the plurality of variables, the method includes generating an aggregate variable score for each variable of the plurality of variables. Based upon the aggregate variable score and a respective weight corresponding to the aggregate variable score for each variable of the plurality of variables, the method includes computing a respective location index for each location of a plurality of location for a job according to the job requirement. The method includes causing display of each location of the plurality of locations for the job along with the respective location index. The respective location index identifies a proposed recommendation for each location of the plurality of locations.

The present disclosure further describes a system for implementing the method provided herein. The present disclosure also describes a non-transitory computer-readable storage media (CRM) having instructions stored thereon which, when executed by one or more processors of a computing device, cause the computing device to perform operations in accordance with the method described herein.

It is appreciated that method in accordance with the present disclosure can include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example environment used to execute implementations of the present disclosure.

FIG. 2 depicts an example architecture of a system disclosed in the example environment of FIG. 1, for generating location recommendations for jobs, in accordance with implementations of the present disclosure.

FIG. 3 depicts an example conceptual architecture of a data preprocessing engine of the system depicted in FIG. 2, for generating an output by processing data, in accordance with implementations of the present disclosure.

FIG. 4 depicts an example conceptual architecture of a location recommendation engine of the system depicted in FIG. 2, for generating a location recommendation for a job, in accordance with implementations of the present disclosure.

FIG. 5 depicts an example graph illustrating equal-sized bins or quartiles corresponding to sub-variables generated for each variable, in accordance with implementations of the present disclosure.

FIG. 6A depicts an example illustration of providing location recommendations and insights for jobs, in accordance with implementations of the present disclosure.

FIG. 6B depicts an example illustration of providing location recommendations and insights for a selected job, in accordance with implementations of the present disclosure.

FIG. 6C depicts an example illustration of providing insights for a location selected for a job, in accordance with implementations of the present disclosure.

FIG. 7 is a flow diagram that presents an example computer implemented method for generating the location recommendations for the jobs, in accordance with implementations of the present disclosure.

FIG. 8 depicts an example computer system to implement a system disclosed in the example environment of FIG. 1, in accordance with implementations of the present disclosure. Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series, and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality or acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

An entity (e.g., an organization, an enterprise, a manufacturing industry, a factory, and/or the like) uses a strategic expansion framework to scale its operations, or to deploy its existing products or services in multiple locations within a particular geographical area or different geographical areas, thereby the entity's reach, influence and operations may be expanded. For such expansions, the entity may plan to create multiple new jobs. Alternatively, the entity may decide to consolidate or merge different operation units or departments, which may result in merging of the multiple jobs. Therefore, it is important for the entity to determine appropriate locations for the new jobs or the merged jobs (hereinafter collectively referenced to as jobs). Determining the appropriate locations for the jobs may assist the organization in making workforce planning and in determining talent transformation strategy of either the whole entity or specific units. Even though, the present disclosure refers to job creation or job consolidation across different geographical areas, various embodiments, as described in the present disclosure, may also be applied for other use cases related to geographical diversity.

Various location recommendation systems may exist for recommending one or more locations for a job. However, the existing location recommendation systems may recommend the one or more locations for the job based on evaluation of available or limited set or criteria such as location data or site data and logistical considerations. In some examples, the existing location recommendation systems may involve human resources to evaluate the available or limited set of criteria and/or validating the recommended one or more locations for the job. Therefore, the existing location recommendation systems may fail to accurately assess and determine readiness of the one or more locations for the job. In addition, the existing location recommendation systems may fail to consider different attributes related to the jobs or requirements of the jobs, while recommending the one or more locations for the job. As a result, the existing location recommendation systems may require a significant amount of time, human resources, and computing resources (e.g., processing resources, memory resources, communication resources, and/or the like) for recommending the one or more locations for the job. In addition, the recommended one or more locations may not be the optimal locations for the job, which may further hinder sourcing of talent for the respective job.

For example, consider that an existing location recommendation system may recommend a location A for a job A based on available site data and logistical considerations of the location A, thereby the location A may employ a number of employees. However, if a maximum number of employees may routinely travel or work off-site, then the location A may not be the optimal location for the job A. Further, with this discrepancy, resources allocated to the location A may be underutilized, while not reflecting requirements of the job A. Accordingly, the resources are often unexploited, resulting in a loss of time, cost, and efficiency.

Implementations of the present disclosure provide a multi-faceted rule-based framework for generating a location recommendation for a job by performing qualitative and quantitative evaluation and ranking of multiple locations available for the job in accordance with skill goals of the entity. The location recommendations may recommend one or more locations from the multiple locations for the job along with their location indices, which may aid in deriving the most desirable location to source talent for achieving growth and improving a talent cost structure of the organization.

Implementations of the present disclosure provide a weighted scoring method, which may consider multiple variables such as cost, capacity, capability, and other additional statistics and their weighted average scores and default weights for computing the location indices for the multiple locations. The location indices may be used to rank the multiple locations. As a result, the multiple locations may be compared against the location indices and an optimal location (e.g., a location with the highest location index) may be selected from the multiple location indices for the job.

Implementations of the present disclosure further enable performing of sensitivity analysis tests to assess how default weights of the cost, the capacity, the capability, and other additional statistics impact the location indices of the multiple locations, providing insight into the reliability of the recommended one or more locations for the job.

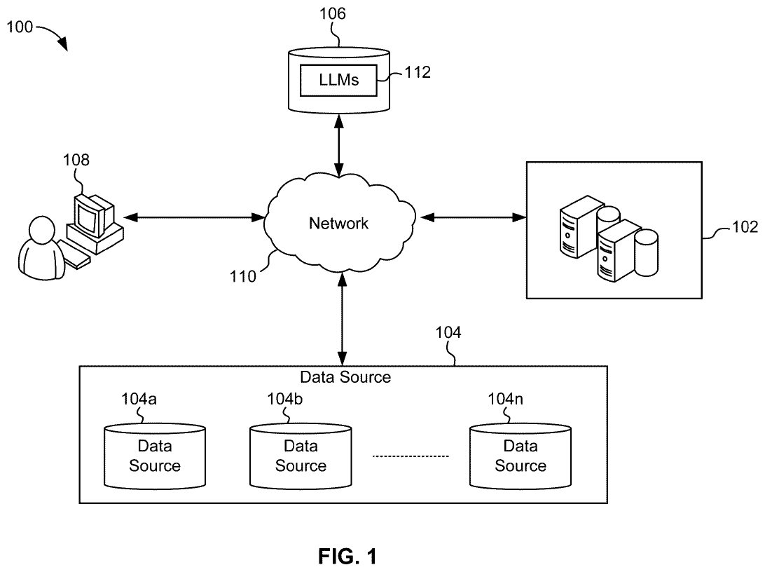

FIG. 1 depicts an example environment 100 that may be used to execute implementations of the present disclosure. The example environment 100, depicted in FIG. 1, includes a system 102, a data source 104, a model database 106, and a user device 108. The system 102 (also be referenced to as a location recommendation system) may communicate with the data source 104, the model database 106, and the user device 108 using a network 110. In some examples, the network 110 may include a Local Area Network (LAN), a Wide Area Network (WAN), the Internet, or a combination thereof. In some examples, the network 110 may be accessed over a wired and/or a wireless communication link. It should be noted that in some implementations, the system 102 may include the model database 106 and the user device 108.

The data source 104 may include data sources 104a-104n, which may be operated by different data providers. For example, the data providers may include, but are not limited to, third-party service providers, talent data providers or talent recruiters, government databases, public databases, industrial databases, partner or stakeholder databases, and/or the like. The data sources 104a-104n may include data. In some examples, the data may be related to one or more of: employment data, location data, logistical considerations, and/or the like. In some examples, the employment data may indicate availability and capability of talents for each of multiple locations, employment data fields for multiple jobs, industries or domains associated with the jobs, and/or the like. The employment data fields may indicate one or more of: skills, roles, skill certificates, job profiles, skill profiles, and/or the like, of the talents. As would be understood, the employment data may be collected, stored, used, and updated (e.g., modified or deleted) based on explicit consent received from the respective talents. In the present disclosure, the talents may refer to human resources or candidates who have been registered with one of the different data providers, for example, the talent recruiter, for an employment opportunity or a job. In some examples, the location data may indicate the multiple locations available for each of the multiple jobs. In the present disclosure, the multiple locations may include locations within a same geographical area or different geographical areas (e.g., metropolitan cities, states, countries, and/or the like).

The model database 106 may include Large Language Models (LLMs) 112. In the present disclosure, the LLMs 112 may also be referenced to as foundation models, Generative Artificial Intelligence (GAI) models, and/or the like. An LLM of the LLMs 112 may be a general-purpose GAI model like a large deep learning neural network, which may be trained using a broad range of generalized and unlabeled training data to perform the one or more tasks such as, human computer interactions (e.g., question and answering), automating process execution, process planning, generating step-by-step procedures for the process execution, performing data analysis, and/or the like. In the present disclosure, the LLMs 112 may be trained or configured using one of different platforms for processing the data. By way of non-limiting example, the LLMs 112 may be trained using Databrick platform. While implementations of the present disclosure are described in further detail herein with non-limiting reference to the LLMs 112, it is contemplated that implementations of the present disclosure may be realized using any appropriate foundation models or Machine Learning (ML) models, or Artificial Intelligence (AI) models.

The user device 108 may be associated with an entity (e.g., an organization, an enterprise, a retail industry, an equipment industry, and/or the like) and operated by a user of the entity. In some examples, the user device 108 may include a desktop, smartphones, laptops, a tablet, and/or the like. The user device 108 may present one or more user interfaces (e.g., Graphical User Interfaces (GUIs)) of a workspace for the user to interact with the system 102. The user device 108 may be used to provide input and/or receive output to or from the system 102. The input may indicate a job, and the output may indicate a location recommendation for the job. The location recommendation may indicate one or more locations for the job and a location index for each of the one or more locations, which is described in detail below.

The system 102 may be implemented as an on-premises system that is operated by an enterprise or a third-party engaged in cross-platform interactions and data management. In some examples, the system 102 may be implemented as an off-premises system (e.g., cloud or on-demand) that is operated by an enterprise or a third-party on behalf of an enterprise. In some examples, the system 102 may be implemented in a cloud environment. For simplicity, the system 102 depicted in FIG. 1 may be a cloud environment that is intended to represent various forms of servers including a web server, an application server, a proxy server, a network server, a server pool, and/or the like.

In some examples, the system 102 may be implemented by way of a single device or a combination of multiple devices that may be operatively connected or networked together. The system 102 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, two or more lines of code, or other suitable software structures operating in one or more software applications.

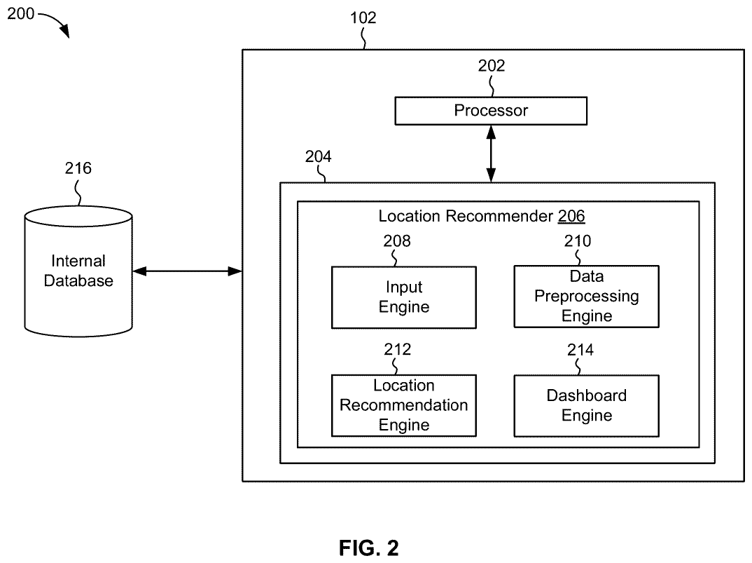

The system 102 may generate the location recommendation for the job. In an implementation, the system 102 may extract the data for the job from one or more of the data sources 104a-104n, preprocess the data using one or more of the LLMs 112 to generate an output, and process the output to generate the location recommendation. The location recommendation may include location index of each of the multiple locations available for the job according to the job requirements. The location index may identify a proposed recommendation for the respective location. Various examples depicting generation of the location recommendation is described in detail in conjunction with FIGS. 2-8.

FIG. 2 depicts an example architecture 200 of the system 102 disclosed in the example environment 100 of FIG. 1, for generating the location recommendations for the jobs, in accordance with implementations of the present disclosure.

As depicted in FIG. 2, the system 102 includes a processor 202 and a memory 204 communicably coupled to the processor 202. The processor 202 may include one or more processors. Examples of the processor 202 may include, but are not limited to, microprocessors, microcomputers, microcontrollers, digital signal processors, central processing units, state machines, logic circuits, and/or any devices that manipulate data or signals based on operational instructions. Among other capabilities, the processor 202 may fetch instructions (also be referenced to as processor-executable instructions or machine-executable instructions) from the memory 204 and execute the fetched instructions for performing operations according to the present disclosure. The memory 204 may be non-volatile or non-transitory computer-readable medium (CRM) such as, a magnetic disk or solid-state non-volatile memory or volatile medium such as Random Access Memory (RAM), and/or the like. Further, the system 102 includes a location recommender 206. The location recommender 206 may be stored in the memory 204 and provided as a downloadable library including the instructions. The location recommender 206 includes an input engine 208, a data preprocessing engine 210 (also be referenced to as data parsing, ingestion, and extraction engine), a location recommendation engine 212, and a dashboard engine 214. The location recommender 206 may be communicatively coupled with an internal database 216. The internal database 216 may store various data and intermediate results generated by the input engine 208, the data preprocessing engine 210, the location recommendation engine 212, and the dashboard engine 214.

In an implementation, the processor 202 may execute the input engine 208 to receive an input. In some examples, the input may be received from the user device 108 (depicted in FIG. 1) associated with the entity. In some other examples, the input may be received from one or more applications being executed on the system 102.

In some examples, the input may identify a job created by the entity and for which the location recommendation has be to be provided. The job may indicate an opportunity available for the talents to perform prerequisite works or tasks or functions. The job may be associated a requirement, which may be hereinafter referenced to as a job requirement. The job requirements may indicate one or more roles, one or more skills, and/or the like, of the talents required for performing the prerequisite works or tasks or functions. The job may correspond to any of various domains such as corporate services, retail industries, equipment industries, healthcare or pharmaceutical industries, fashion industries, and/or the like. By way of non-limiting example, the job related to the corporate services may identify an opportunity available for roles such as a product manager, a technical lead, software developer, a tester, an interface designer, and/or the like.

In some other examples, the input may indicate location requirements along with the job. The location requirements may indicate one or more of variables (also be referenced to as attributes), which have been prioritized by the entity for receiving the location recommendations. The variables may correspond to the job requirement. In the present disclosure, the variables may include cost, capability, and capacity. The cost, the capability, and the capacity may be supplemented with additional statistics (also be referenced to as additional attributes). The cost may be an amount of wages in any particular location to acquire the talent, a corporate benefit liability, and a corporate tax rate. The capacity may indicate availability of the talents in any particular location or an ability to source or draw the talents to any particular location to perform and complete requisite work. The capability may indicate a depth of skills and knowledge of the talents available for roles in any particular location.

In some examples, the input engine 208 may classify the variables into a primary category and a secondary category, based upon the received location requirements. Such a classification of the variables may prioritize the variables. In an example, the variables such as the cost and the capability may be classified into the primary category and a variable like capacity may be classified into the secondary category, thereby the cost and the capability may be prioritized over the capacity. In such a scenario, cost-effective locations from the multiple locations may be recommended for the job, where target skills or roles are accessible prioritizing cost and capability. In another example, the variables such as the cost and the capacity may be classified into the primary category and the variable like capability may be classified into the secondary category, thereby the cost and the capacity may be prioritized over the capability. In such a scenario, cost and capacity effective locations from the multiple locations may be recommended for the job. In yet another example, the variables such as the capacity and the capability may be classified into the primary category and the variable like cost may be classified into the secondary category, thereby the capability and the capacity may be prioritized over the cost. In such a scenario, capacity-effective locations from the multiple locations may be recommended for the job, where target skills or roles are accessible, prioritizing capacity and capability. In yet another example, the variable like the cost may be classified into the primary category and the variables such as the capacity and the capability may be classified into the secondary variables. In such a scenario, only cost-effective locations from the multiple locations may be recommended.

The input engine 208 may store the input (e.g., the job and/or the location requirements) and a respective category defined for each variable in the internal database 216.

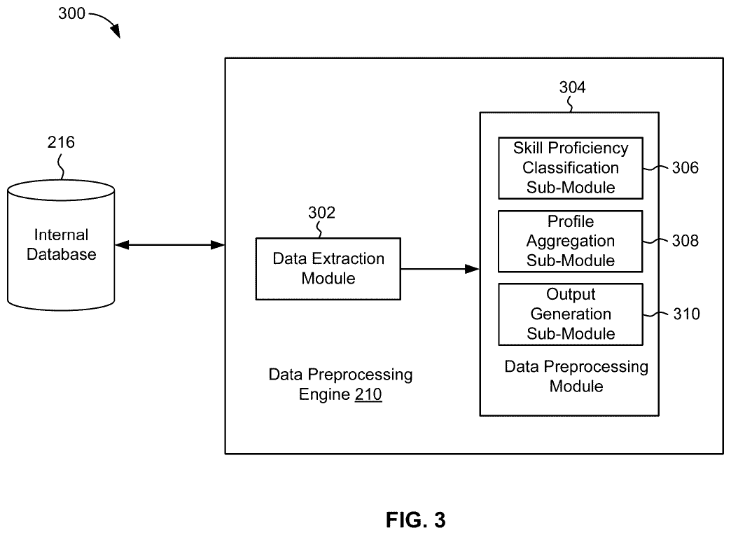

In an implementation, the processor 202 may execute the data preprocessing engine 210 to acquire data related to the job from one or more of the data sources 104a-104n and preprocess the acquired data to generate an output. The acquired data may be related to the employment data including the employment data fields, the location data indicating the multiple locations available for the job, and the logistical considerations. The logistical considerations may indicate how the multiple locations may impact various factors associated with the job and/or the associated entity. Examples of the factors may include, but are not limited to, operational efficiency of the entity, cost structure, inventory management, quality control, communication, compliance, and/or the like. The output may include one or more sub-variables corresponding to each of the variables such as the cost, the capability, the capacity, the additional statistics, and/or the like. Examples of the one or more sub-variables may include but are not limited to, a talent wage, a corporate benefit liability, skill availability, skill proficiency, talent availability, corporate income tax bracket, talent availability, a level of competition, and/or the like. The output may be stored in the internal database 216. Preprocessing of the data to generate the output is described in detail in conjunction with FIG. 3.

In an implementation, the processor 202 may execute the location recommendation engine 212 to generate a location recommendation for the job by processing the one or more sub-variables of each variable. The location recommendation may propose a location index for each of the multiple locations available for the job or top-k locations from the multiple locations for the job. The top-k locations may include a number of locations predefined by the entity or the system 102. Further, the number of locations may be dynamically varied according to the entity or the job requirement or a type of the job. In some examples, the top-k locations may include 5 locations.

In some other examples, the top-k locations may include 3 locations. Using the location recommendation, the entity may select an optimal location for the job. The optimal location may be a location associated with the highest location index among other locations.

The location recommendation engine 212 may compute a respective score for each of the one or more sub-variables of each of the variables using a quantile-based discretization function.

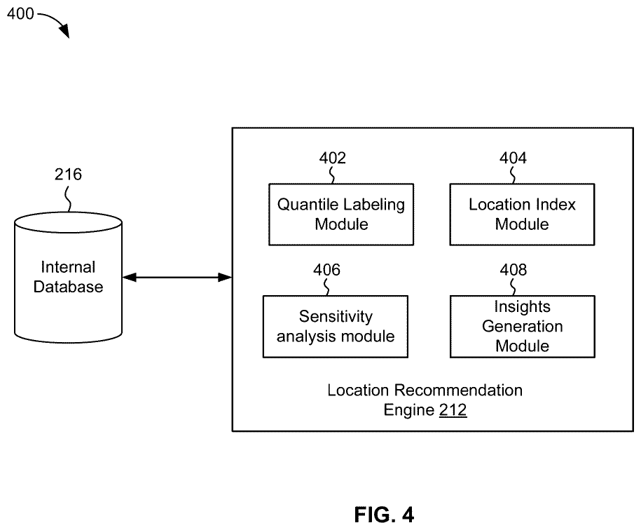

Based upon a respective weight and the respective score of each of the one or more sub-variables, the location recommendation may generate an aggregate variable score for each of the respective variables. Further, based upon the aggregate variable score and a respective weight of each of the variables, the location recommendation engine 212 may compute a respective location index for each of the multiple locations available for the job according to the job requirement. Generating the location recommendation by computing the location index for each of the multiple locations is described in detail in conjunction with FIG. 4.

In an implementation, the processor 202 may execute the location recommendation engine 212 to evaluate the respective weight of each of the variables using sensitive analysis tests, which is described in detail in conjunction with FIG. 4. Based on the evaluation, the location recommendation engine 212 may assess how the respective weight of each of the variables impact the location index of each of the multiple locations.

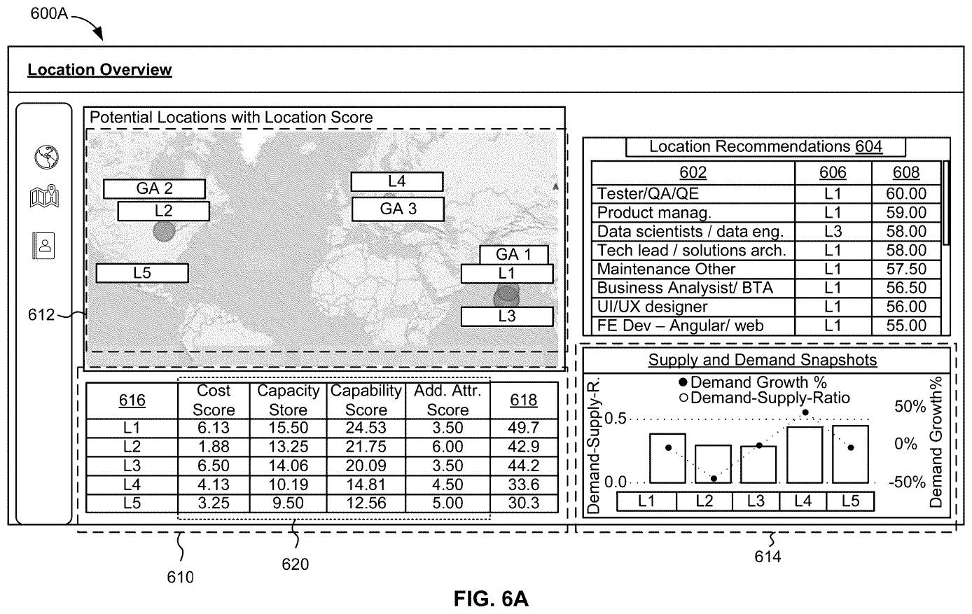

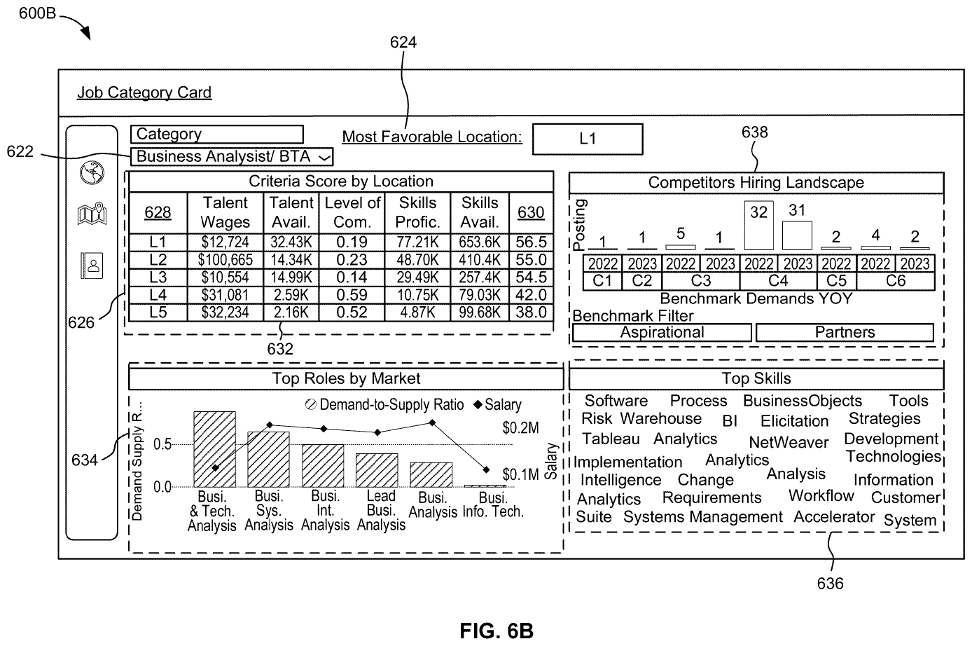

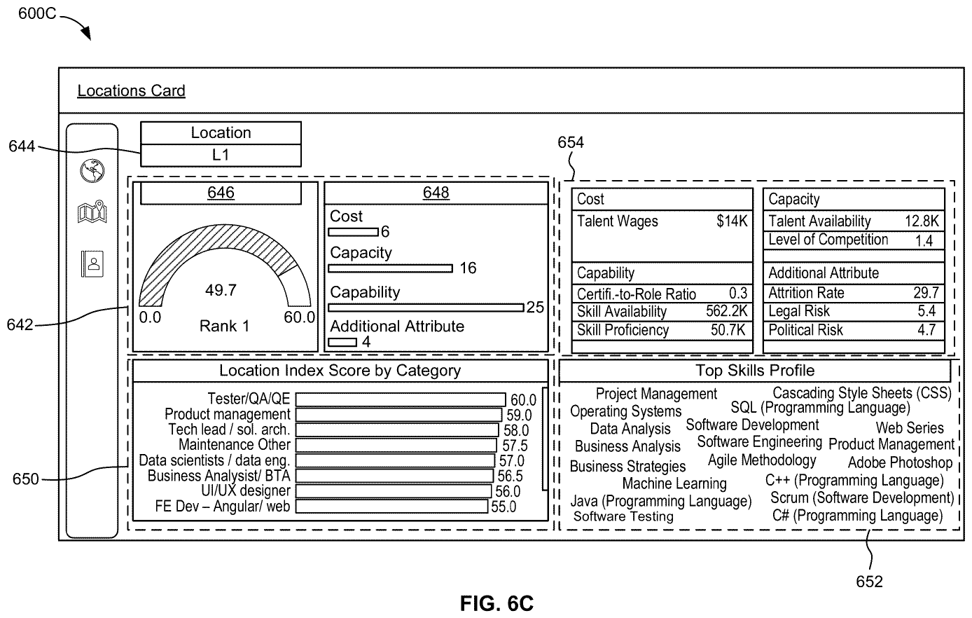

In an implementation, the processor 202 may execute the location recommendation engine 212 to generate insights about each of the variables with respect to each of the multiple locations based on its respective aggregate variable score. Also, the insights about each of the sub-variables of each variable may be generated based on the respective score with respect to each of the multiple locations. In addition, the insights about each of the multiple locations may be generated based on its location index. In some examples, the insights may be generated based upon performing the sensitive analysis tests. In some examples, the insights may provide information about a competitor size, operational domains, an impact within a local market, and/or the like. Example illustrations of the insights are described in conjunction with FIGS. 6A, 6B, and 6C. The location index of each of the multiple locations and the insights corresponding to the job may be stored in the internal database 216.

In an implementation, the processor 202 may execute the dashboard engine 214 to cause display of the location index of each of the multiple locations and the insights. In some examples, the dashboard engine 214 may cause display of the location index of each of the multiple locations and the insights on a user interface of the system 102. In some other examples, when the input is received from the user device 108 (depicted in FIG. 1), the dashboard engine 214 may cause display of the location index of each of the multiple locations and the insights on the user interface of the user device 108. Therefore, the entity or the user of the entity may select the optimal location from the multiple locations for the job. The selected optimal location may be used for setting up a workplace or an office by the entity for the job.

FIG. 3 depicts an example conceptual architecture 300 of the data preprocessing engine 210 of the system 102 depicted in FIG. 2, for generating the output by processing the data, in accordance with implementations of the present disclosure. The data preprocessing engine 210 depicted in FIG. 3, includes a data extraction module 302 and a data preprocessing module 304.

The data extraction module 302 may receive the input including the job and/or the location requirements from the input engine 208 or the internal database 216. Based on the input, the data extraction module 302 may acquire or extract the data. In some examples, the data may be acquired from one or more of the data sources 104a-104n. The data extraction module 302 may acquire the data using any suitable feature extraction tools, which are known and not further described herein.

Acquiring the data using the feature extraction tools may involve extracting the data from one or more of the data sources 104a-104n through an Application Programming Interface (API) and using one or more filters such as the job requirement corresponding to the job, an industry or domain related to the job, and any particular geographical area (e.g., specified by the entity) corresponding to the job. Therefore, the data relevant to the job requirement, the industry, and the particular geographical area may be acquired. In some examples, the acquired data may include employment data including the employment data fields corresponding to the job requirement, the location data indicating the multiple locations available within the geographical area according to the job requirement, and the logistical considerations associated with the multiple locations. The employment data fields may include one or more roles or categories, one or more skills, job profiles, skill profiles, salary details, and/or the like. In some other examples, the data extraction module 302 may extract the data or at least portion of the data from the internal database 216, if the data or at least portion of data extracted for previous location recommendations is stored in the internal database 216. The data extraction module 302 may provide the acquired or extracted data to the data preprocessing module 304.

The data preprocessing module 304 may preprocess the acquired data, for example, the employment data, to generate the output for each of the multiple locations available for the job according to the job requirement. The data preprocessing module 304 includes a skill proficiency classification sub-module 306, a profile aggregation sub-module 308, and an output generation sub-module 310, as depicted in FIG. 3.

The skill proficiency classification sub-module 306 may compute a certificate class category (also be referenced to a certificate profile) for each of the one or more skills with respect to each of the multiple locations and determine certificate proficiency levels with certificate profiles. The skill proficiency classification sub-module 306 may select the one or more skills according to the job requirement from the acquired data for each of the multiple locations and identify one or more certificates corresponding to the selected one or more skills. Further, the skill proficiency classification sub-module 306 may identify a name of each certificate, and a description of each certificate. In addition, the skill proficiency classification sub-module 306 may identify classification labels predefined for classification of the one or more skills by accessing the internal database 216. In some examples, the classification labels may include beginner, intermediate, and advanced. Upon the identification, the skill proficiency classification sub-module 306 may generate the certificate class category for each of the one or more skills with respect to each of the multiple locations by processing the name of each certificate and the description of each certificate corresponding to each skill and the predefined classification labels. In some examples, the name of each certificate and the description of each certificate corresponding to each of the one or more skills and the predefined classification labels may be processed using an LLM from the LLMs 112 (depicted in FIG. 1) or using a prompt engineering framework like DSPy prompt engineering framework. The DSPy prompt engineering framework may be configured to integrate the LLMs 112 such as Generative Pre-trained Transformer-3.5 (GPT-3.5), GPT-4 and Llama2-13b Therefore, the certificate class category may be generated for each of the one or more skills by selecting an appropriate (e.g., best match) classification label from the predefined classification labels. In some examples, the certificate class category may be generated in a form of JavaScript Object Notation (JSON) tag.

After generating the certificate class category for each of the one or more skills with respect to each of the one or more locations, the skill proficiency classification sub-module 306 may determine certificate proficiency levels for each of the one or more locations and certificate profiles for each of the certificate proficiency levels. The certificate proficiency levels determined for the location may indicate levels such as “advanced,” “intermediate,” and “beginner.” The certificate proficiency levels may be determined by processing the certificate class category of each of the one or more skills with respect to each of the multiple locations, using an AI-powered certificate categorization model. The certificate proficiency levels determined for the location may indicate levels such as “advanced,” “intermediate,” and “beginner.” For example, the certificates corresponding to each of the one or more skills falling under a certificate class category may identify a number of certificate profiles for a respective location. The identified number of certificate profiles may be aggregated for the certificate proficiency level corresponding to the certificate class category and the respective location. By way of non-limiting example, 256 certificates corresponding to a skill ‘A’ with respect to a location ‘A’ and 345 certificates corresponding to a skill ‘B’ with respect to the location ‘A’ may be assigned with a certificate class category like ‘beginner.’ In such an example, a total number of certificate profiles determined for a certificate proficiency level ‘beginner’ may include 601 (e.g., 256+345). Therefore, the certificate profiles determined for the certificate proficiency level, for example, “beginner,” with respect to the location may indicate a number of certificate profiles identified for the “beginner” in the location.

The profile aggregation sub-module 308 may aggregate multiple details from the acquired data for each of the multiple locations. For example, the profile aggregation sub-module 308 may select the one or more roles and the one or more skills from the acquired data for each of the multiple locations according to the job requirement, while removing other data. The profile aggregation sub-module 308 may further derive or compute an average salary for each of the multiple locations according to the job requirement, while removing employment fields, for example, salary details with zero value (e.g., NULL value). In some examples, the average salary may be computed by accessing and analyzing job posting information acquired or extracted from one or more of the data sources 104a-104n. The profile aggregation sub-module 308 may further extract job profiles, skill profiles, benefit plans, and/or the like, available for each of the multiple locations from the acquired data. Upon the extraction, the profile aggregation sub-module 308 may aggregate the extracted one or more roles, average salary, job fields, and skill profiles for each of the multiple locations. Therefore, the multiple details extracted and aggregated for each of the multiple locations may include the one or more roles, average salary, job fields, and skill profiles.

Based on the certificate class category of each skill, the certificate proficiency levels, and the certificate profiles at each of the certificate proficiency levels and the aggregated multiple details for each of the multiple locations, the output generation sub-module 310 may generate the output for each of the multiple locations according to the job requirement. In some implementations, the output generation sub-module 310 may refine the output through multiple iterations performed for evaluation of the location index and ranking computed for each of the multiple locations. The evaluation may be performed using the sensitivity analysis tests, which are described in detail in conjunction with FIG. 4. The multiple iterations may be performed until achieving reliability in recommendations of the multiple locations based on their location indices.

The output may include sub-variables for each of the variables such as the cost, the capacity, and the capability.

The cost may include the sub-variables such as a talent wage, corporate benefit liability, corporate income tax bracket, and/or the like. The talent wage may refer to an amount of wages required to employ the talent in any particular location of the multiple locations. The talent wage for each location may be generated based on the average salary computed for a respective location. The corporate benefit responsibility for each location may be generated based on the aggregated benefit plans (e.g., social security plans, employee benefit plans, and/or the like) for a respective location. Therefore, the corporate benefit liability may be generated by capturing cost impact of minimal payment towards the benefit plans. The corporate income tax for each location may be generated based on income tax decided by a country law for a respective location.

The capability may include the sub-variables such as skill availability, skill proficiency, and/or the like. The skill availability for each location may be generated based on the aggregated skill profiles for a respective location. The skill proficiency for each location may be generated by calculating weighted scores of the certificate profiles determined for each of the certificate proficiency levels with respect to a respective location and the job profiles aggregated for the respective location. The certificate profiles for each of the certificate proficiency levels with respect to each location may be identified from the certificates or skill qualifications corresponding to the one or more skills available for the respective location.

The capacity may include the one or more sub-variables such as talent availability, a level of competition, and/or the like. The talent availability for each location may be generated based on a number of job profiles aggregated for a respective location. The level of competition for each location may be generated by determining a number of similar entities or industries present in the respective location. Therefore, the capacity may indicate the depth of talent availability and competition in each location, based on job profiles and industry presence.

Various examples of generating the sub-variables for each of the capacity, the capability, and the cost are described in detail below.

### Capacity: Talent Availability

The data extraction module 302 may acquire the data from the data sources 104a-104n through the API and using the filters such as the job requirement and the geographical area. In an example herein, consider that the job requirement may indicate a skill list (e.g., including AWS, Amazon, Azure, Google Cloud, Veeva, ServiceNow, PowerBI, Microsoft copilot, Gen AI, Data Analytics, Data Science, Tableau, Databricks, Machine learning, and Artificial Intelligence), and the geographical area may indicate “county A.” In such an example, the acquired data may include the employment data related to the job requirement and locations (e.g., locations 1-3) available and suitable for the job requirement in the “county A.”

The data preprocessing module 304 may select the job profiles from the employment data for each of locations 1-3 and aggregate the respective job profiles to generate the talent availability for each of the locations 1-3 according to the job requirement, which is illustrated in an example table 1.

TABLE 1
Talent availability generated for each of the locations 1-3

| Location | Talent Availability |
|---|---|
| Location 1 | 2740 |
| Location 2 | 542 |
| Location 3 | 290 |

### Capacity: Level of Competition

The data extraction module 302 may acquire the data from the data sources 104a-104n through the API and using the filters such as a job requirement, an industry, and a geographical area. In an example herein, consider that the job requirement may indicate a skill list, the geographical area may indicate “county A,” and the industry may indicate “pharma and science companies.” In such an example, the acquired data may include the employment data related to the job requirement and locations (e.g., locations 1-3) available and suitable for the job requirement in the “county A,” and information about entities belonging to the “pharma and science companies.”

Based on the acquired data, the data preprocessing module 304 may identify a number of entities belonging to the “pharma and science companies,” for each of the locations 1-3, while removing a name of an entity. The data preprocessing module 304 may aggregate the identified number of entities for each of the locations 1-3 to generate the level of competition for each of the locations 1-3, which is illustrated in an example table 2.

TABLE 2
Level of competition generated for each of the locations 1-3

| Location | Level of Competition |
|---|---|
| Location 1 | 140 |
| Location 2 | 81 |
| Location 3 | 47 |

### Capability: Skill Availability

The data extraction module 302 may acquire the data from the data sources 104a-104n through the API and using the filters such as the job requirement and the geographical area. In an example herein, consider that the job requirement may indicate a skill list, and the geographical area may indicate “county A.” In such an example, the acquired data may include the employment data related to the job requirements and locations (e.g., locations 1-3) available and suitable for the job requirement in the “county A.”

The data preprocessing module 304 may extract the skill profiles from the employment data for each of the locations 1-3 and aggregate the skill profiles of each of the locations 1-3 to generate the skill availability for each of the locations 1-3. In some examples, the data preprocessing module 304 may extract a predefined number of skill profiles (e.g., top-k profiles, where k=100) for each of the locations 1-3 according to the job requirement and aggregate the predefined number of skill profiles to generate the skill availability for each of the locations 1-3. which is illustrated in an example table 3.

TABLE 3
Skill availability generated for each of the locations 1-3

| Location | Skill Availability |
|---|---|
| Location 1 | 18083 |
| Location 2 | 4401 |
| Location 3 | 2070 |

### Capability: Skill Proficiency

The data extraction module 302 may acquire the data from the data sources 104a-104n through the API and using the filters such as the job requirement and the geographical area. In an example herein, consider that the job requirement may indicate a skill list, and the geographical area may indicate “county A.” In such an example, the acquired data may include the employment data related to the job requirement and locations (e.g., locations 1-3) available and suitable for the job requirement within the “county A.”

Based on the acquired data, the data preprocessing module 304 may identify pre-defined number of skill profiles (e.g., top-k profiles, where k=100) for each of the locations 1-3 according to the job requirement. The data preprocessing module 304 may determine certificate proficiency levels associated with the pre-defined number of skill profiles for each of the locations 1-3 according to the job requirement. By way of non-limiting example, the data preprocessing module 304 may use an AI powered certificate categorization model to determine the certificate proficiency levels. Further, the data preprocessing module 304 may determine a weighted score of each certificate profile at the determined certificate proficiency levels for each of the locations 1-3. Based on the certificate proficiency levels and the weighted score of each certificate profile at the determined certificate proficiency levels for each of the locations 1-3, the data preprocessing module 304 may generate the certificate proficiency level for each of the locations 1-3. Examples of the certificate profiles at each of the different certificate proficiency levels, the weighted score of each certificate profile, and the skill proficiency for each of the locations 1-3 are illustrated in a table 4A, a table 4B, and table 4C, respectively.

TABLE 4
Certificate profiles at different proficiency levels

| | Certificates Profiles | | |
|---|---|---|---|
| Locations | Advanced | Beginner | Intermediate |
| Location 1 | 442 | 257 | 576 |
| Location 2 | 96 | 65 | 108 |
| Location 3 | 75 | 45 | 122 |

Weighted scores of certificate profiles at different proficiency levels

| | | | |
|---|---|---|---|
| Weights | 0.5 | 0.1 | 0.3 |
| Locations | Advanced | Beginner | Intermediate |
| Location 1 | 221 | 25.7 | 172.8 |
| Location 2 | 48 | 6.5 | 32.4 |
| Location 3 | 37.5 | 4.5 | 36.6 |

Skill proficiency generated for each of the locations 1-3

| Locations | Skill Proficiency |
|---|---|
| Location 1 | 419.5 |
| Location 2 | 86.9 |
| Location 3 | 78.6 |

### Cost: Talent Wages

The data extraction module 302 may acquire the data from the data sources 104a-104n, for example, via Snowflakes Query, and using the filters such as the job requirement and the geographical area. In an example herein, consider that the job requirement may indicate a skill list, and the geographical area may indicate “county A.” In such an example, the acquired data may include the employment data related to the job requirement and locations (e.g., locations 1-3) available and suitable for the job requirement in the “county A.”

The data preprocessing module 304 may extract a salary with respect to each skill in the skill list for a predefined duration (e.g., 2 years) and for each of the locations 1-3. Upon the extraction, the data preprocessing module 304 may compute an average of all salaries of skills in the skill list for generating the talent wages for each of the locations 1-3, which is illustrated in an example table 5.

TABLE 5
Talent wages generated for each of the locations 1-3

| Location | Talent Wages |
|---|---|
| Location 1 | $144,095 |
| Location 2 | $140,787 |
| Location 3 | $138,118 |

### Cost: Corporate Income Tax

The data extraction module 302 may acquire the data related to corporate income tax index for each of the locations 1-3 from one of the data sources 104a-104n. In an example herein, the data source may include a government tax foundation website. The data preprocessing module 304 may derive an upper limit value from the acquired corporate income tax index for each of the locations 1-3 and use the derived upper limit value for generating the corporate income tax for each of the locations 1-3, which is illustrated in an example table 6.

TABLE 6
Corporate income tax generated for each of the locations 1-3

| Location | Corporate Income Tax |
|---|---|
| Location 1 | 23 |
| Location 2 | 25 |
| Location 3 | 21 |

### Cost: Corporate Benefit Liability

The data extraction module 302 may acquire the data related to the benefit plans for each of the locations 1-3 from one of the data sources 104a-104n. The data preprocessing module 304 may derive an upper limit value from the acquired benefit plans for each of locations 1-3 and use the derived upper limit value for generating the corporate benefit liability for each of the locations 1-3, which is illustrated in an example table 7.

TABLE 7
Corporate benefit liability generated for each of the locations 1-3

| Location | Corporate Benefit Liability |
|---|---|
| Location 1 | 5.8 |
| Location 2 | 20.9 |
| Location 3 | 6.3 |

Further, the generated output including the sub-variables for each of the locations 1-3 is illustrated in an example aggregated table 8 below.

TABLE 8
Output including sub-variables generated for each of the locations 1-3

| | | Corporate | Corporate | | | Level | |
|---|---|---|---|---|---|---|---|
| | Talent | Income | Benefit | Skill | Skill | of | Talent |
| Location | Wages | Tax | Liability | Availability | Proficiency | Competition | Availability |
| Location | $144,095 | 23 | 5.8 | 18083 | 419.5 | 140 | 2740 |
| 1 | | | | | | | |
| Location | $140,787 | 25 | 20.9 | 4401 | 86.9 | 81 | 542 |
| 2 | | | | | | | |
| Location | $138,118 | 21 | 6.3 | 2070 | 78.6 | 47 | 290 |
| 3 | | | | | | | |

Additionally, or alternatively, the variables such as the cost, the capacity, and the capability may be supplemented with the additional statistics. In such a scenario, the sub-variables may be generated for the additional statistics using the data extraction module 302 and the data preprocessing module 304. Examples of the sub-variables generated for the additional statistics may include, but are not limited to, time difference, travel time, a legal risk, a potential risk, an attrition rate, a cost of living, an inflation rate, a stringency index, and/or the like.

For generating the time difference, the data extraction module 302 may acquire the data related to different time zones of the multiple locations from one or more of the data sources 104a-104n. The data preprocessing module 304 may generate the time difference for each location by selecting a time zone for a respective location from the acquired data and calculating a difference between the selected time zone and Central Standard time zone.

For generating the travel time, the data extraction module 302 may acquire the data indicating travel time for each of the multiple locations with respect to different mode of transport, from one or more of the data sources 104a-104n. The data preprocessing module 304 may generate the travel time for each location based on a mode of transport selected for a respective location and the associated travel time.

For generating the legal risk, the data extraction module 302 may acquire the data related to legal risk index scores available for the multiple locations, from one or more of the data sources 104a-104n. The legal risk index scores may be provided to the multiple locations according to their respective country or local law. A legal risk index score may measure a degree to which collateral and bankruptcy laws protect rights of borrowers and lenders, thereby facilitate lending. In some examples, the legal risk index score may vary from ‘0’ (e.g., minimum or lowest score) to ‘12’ (maximum or highest score). The legal risk index score with the highest score may indicate that the associated collateral and bankruptcy laws may be designed to expand access to credit. The data preprocessing module 304 may generate the legal risk for each location by deriving the legal risk index score for a respective location from the acquired data and preprocessing the extracted legal risk index score.

For generating the potential risk, the data extraction module 302 may acquire the data related to potential stability index scores available for the respective multiple locations, from one or more of the data sources 104a-104n. A potential stability index score of a location may indicate political stability (e.g., a stability of a ruling government in the location) and absence of violence in the location, thereby measuring perceptions of the likelihood that the ruling government may be destabilized or overthrown by unconstitutional or violent means. The data preprocessing module 304 may generate the potential risk for each location by deriving the potential stability index score for a respective location from the acquired data and preprocessing the extracted potential stability index score.

For generating the attrition rate, the data extraction module 302 may acquire the data related to attrition rates corresponding to multiple locations, from one or more of the data sources 104a-104n. The data preprocessing module 304 may generate the attrition rate for each location by selecting an attrition rate for a respective location. Similarly, the data preprocessing module 304 may generate the inflation rate for each location based on current inflation rate acquired for a respective location.

For generating the cost of living, the data extraction module 302 may acquire the data related to monthly rent corresponding to each of the multiple locations, from one or more of the data sources 104a-104n. The data preprocessing module 304 may generate the cost of living for each location by computing an average of the monthly rent corresponding to each of the multiple locations.

For generating the stringency index, the data extraction module 302 may acquire the data including one or more metrics corresponding to each of the multiple locations, from one or more of the data sources 104a-104n. The one or more metrics may include school closures, workplace closures, cancellation of public events, restrictions on public gatherings, closures of public transport, work from home or offsite requirements, public information campaigns, restrictions on internal movements, international travel conditions, and/or the like. The data preprocessing module 304 may generate the stringency index for each location by analyzing the one or more metrics corresponding to a respective location. While implementations of the present disclosure are described by considering the sub-variables of each of the cost, the capability, the capacity, and the additional statistics, it is contemplated that implementations of the present disclosure may be realized using any other appropriate variables and the sub-variables.

The data preprocessing module 304 may store the output including the sub-variables for each of the variable with respect to each of the multiple locations in the internal database 216.

FIG. 4 depicts an example conceptual architecture 400 of the location recommendation engine 212 of the system 102 depicted in FIG. 2, for generating the location recommendation for the job, in accordance with implementations of the present disclosure. The location recommendation engine 212, depicted in FIG. 4, includes a quantile labeling module 402, a location index module 404, a sensitivity analysis module 406, and an insights generation module 408.

The quantile labeling module 402 may obtain the output generated for the job from the internal database 216 or from the data preprocessing engine 210. The output may include the sub-variables for each of the variables such as cost, capability, and capacity with respect to each of the multiple locations. The sub-variables may include talent wages, a corporate income tax (also be referenced to as corporate income tax bracket), a corporate benefit liability, skill availability, skill proficiency, talent availability, a level of competition, and/or the like. Once the output is received, the quantile labeling module 402 may compute a respective score for each sub-variable. As would be understood, the respective score for each sub-variable may be computed with respect to each of the multiple locations.

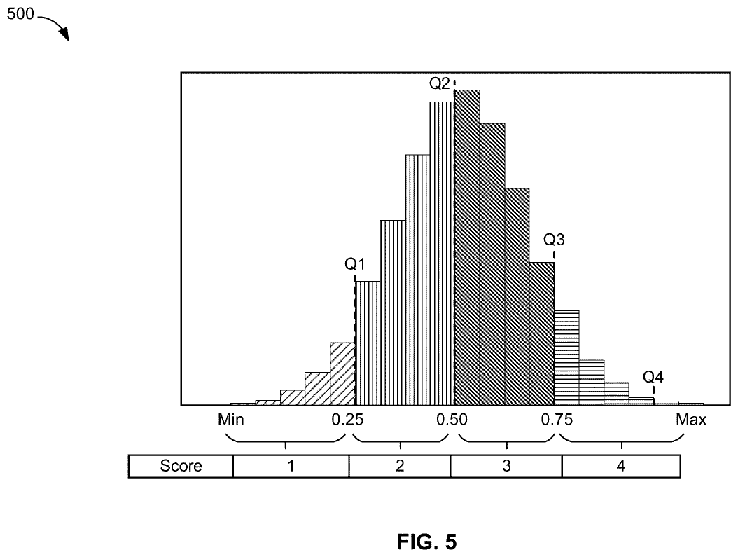

In some examples, the quantile labeling module 402 may compute the respective score for each sub-variable using a quantile-based discretization function. For computing the respective score for each sub-variable, the quantile labeling module 402 may divide the sub-variables into equal-sized bins or quartiles according to quartile distribution of the sub-variables. The equal-sized bins or quartiles may be used to normalize each sub-variable in ‘1’ to ‘4’ range. An example graph 500 illustrating equal-sized bins or quartiles of the sub-variables are illustrated in FIG. 5. As depicted in FIG. 5, a bin 1 or quartile 1 may vary from 0 to 0.25 (e.g., Q1=0-0.25), a bin 2 or quartile 2 may vary from 0.25 to 0.5 (e.g., Q2=0.25-0.5), a bin 3 or quartile 3 may vary from 0.5 to 0.75 (e.g., Q3=0.5-0.75), and a bin 4 or quartile 4 may vary from 0.75 to 1 (e.g., Q4=0.75-1). Further, scores for Q1, Q2, Q3, and Q4 may include 1, 2, 3, and 4, respectively.

Referring back to FIG. 4, upon dividing the sub-variables, the quantile labeling module 402 may determine an impact of each sub-variable on location requirements received from the entity. The location requirements may indicate prioritization of one or more of the variables. In some examples, the location requirements may include requests for cost-effective locations, thereby prioritizing the cost over the capability and the capacity. In some other examples, the location requirements may include requests for talent capability and capacity requests, thereby prioritizing the capability and capacity over the cost. Based upon the determined impact, the quantile labeling module 402 may label each sub-variable using, by way of non-limiting example, reverse and forward labeling. Based on the label of each sub-variable, the quantile labeling module 402 may compute the respective score (also be referenced to as quantile score) for each sub-variable. The respective score for each sub-variable with the reverse labeling may include a low score, and the respective score for each sub-variable with the forward labeling may include a high score. Therefore, the respective score or quantile score of each sub-variable may aid in assessing impact of each sub-variable in its labelled direction.

For example, if the sub-variable like the talent availability is forward labeled, then the locations with a higher number of talent or qualified candidates may be prioritized. As a result, a high score may be computed for the talent availability. For another example, if the sub-variable like the talent wages is reverse labeled, then the location with high talent costs may be reduced while prioritizing the location with low talent costs. As a result, a low score may be computed for the talent wages. In the present disclosure, the specific sub-variables such as the talent wages, the corporate income tax, the corporate benefit liability, and the level of competition may be reverse labeled, thereby high values of such sub-variables may be assigned with low scores (e.g., low quantile scores) to align with an objective of identifying the optimal locations for the job. Conversely, the other sub-variables such as the skill availability, the skill proficiency, and the talent availability may be forward labeled, thereby high values of such sub-variables may be assigned with high scores (e.g., high quantile scores). In some examples, the respective scores of the sub-variables may vary between a scoring range ‘1’ and ‘4’, as the bins or quartiles (Q1-Q4) are assigned with the scores of ‘1’ to ‘4’. Example respective scores of the sub-variables for each of the locations 1-3 are illustrated in a table 9.

TABLE 9
Scores or quantile scores of sub-variables

| | | Corporate | Corporate | | | | |
|---|---|---|---|---|---|---|---|
| | Talent | Income | Benefit | Skill | Skill | Level Of | Talent |
| Location | Wages | Tax | Liability | Availability | Proficiency | Competition | Availability |
| Location | 1 | 3 | 4 | 4 | 4 | 1 | 4 |
| 1 | | | | | | | |
| Location | 3 | 1 | 1 | 2 | 2 | 3 | 2 |
| 2 | | | | | | | |
| Location | 4 | 4 | 3 | 1 | 1 | 4 | 1 |
| 3 | | | | | | | |

In some implementations, the quantile labeling module 402 may transform the sub-variables into different categories, based on the respective scores. By way of non-limiting example, the categories may include low, medium, and high. Transformation of the sub-variables into the different categories may provide clear and actionable insights into a relative performance of each sub-variable.

Once the respective score for each sub-variable is computed, the quantile labeling module 402 may identify a respective weight for each sub-variable. The respective weight for each sub-variable may be a default weight, which may be pre-defined and stored in the internal database 216. In some examples, the respective weight for each sub-variable may be dynamically updated based on a weight update request received from the entity. The weight update request may indicate a specific weight for each of one or more of the sub-variables. For example, a weight pre-defined for the sub-variable like the talent wages may be 0.5. The quantile labeling module 402 may update the weight of the talent wages as 0.7, based upon receipt of the update request from the entity for the talent wages. The respective weight of each sub-variable may reflect its importance in the overall computation of the location index. Example respective weights or default weights of the sub-variables are illustrated in table 10.

TABLE 10
Default weights of sub-variables

| | | Corporate | Corporate | | | | |
|---|---|---|---|---|---|---|---|
| | Talent | Income | Benefit | Skill | Skill | Level Of | Talent |
| | Wages | Tax | Liability | Availability | Proficiency | Competition | Availability |
| Weight | 0.7 | 0.1 | 0.2 | 0.7 | 0.3 | 0.4 | 0.6 |

Upon identifying the respective weight of each sub-variable, the quantile labeling module 402 may compute a weighted average score for each sub-variable with respect to each of the multiple locations. The quantile labeling module 402 may compute a weighted average score for each sub-variable with respect to each of the multiple locations based on the respective score of each sub-variable computed with respect to each of the multiple locations (depicted in table 9) and the respective weight of each sub-variable (depicted in table 10). For example, a weighted average score of a sub-variable may be represented as:

$$Weighted average score of sub - variable = weight * score$$

An example weighted average score of each sub-variable with respect to each of the locations 1-3 is illustrated in a table 11.

TABLE 11
Weighted average scores of sub-variables

| | | Corporate | Corporate | | | | |
|---|---|---|---|---|---|---|---|
| | Talent | Income | Benefit | Skill | Skill | Level Of | Talent |
| Location | Wages | Tax | Liability | Availability | Proficiency | Competition | Availability |
| Location | 0.7 | 0.3 | 0.8 | 2.8 | 1.2 | 0.4 | 2.4 |
| 1 | | | | | | | |
| Location | 2.1 | 0.1 | 0.2 | 1.4 | 0.6 | 1.2 | 1.2 |
| 2 | | | | | | | |
| Location | 2.8 | 0.4 | 0.6 | 0.7 | 0.3 | 1.6 | 0.6 |
| 3 | | | | | | | |

Based on the respective weighted average scores of the sub-variables (depicted in table 11), the quantile labeling module 402 may generate an aggregate variable score for each variable with respect to each of the multiple locations. The aggregate variable score of each variable may ensure that the overall computation of the location index is sensitive to the relative importance of each variable. For example, the aggregate variable score for the cost with respect to each of the multiple locations may be generated based on the weighted average score of each of the talent wages, the corporate income tax, and the corporate benefit liability computed for each of the multiple locations. The aggregate variable score for the capability with respect to each of the multiple locations may be generated based on the weighted average score of each of the skill availability, and the skill proficiency computed for each of the multiple locations. The aggregate variable score for the capacity with respect to each of the multiple locations may be generated based on the weighted average score of each of the talent availability and the level of competition computed for each of the multiple locations. Example aggregate variable scores of the variables such as the cost, the capability, and the capacity are illustrated in table 12.

TABLE 12
Aggregate variable scores of variables

| Location | Cost | Capability | Capacity |
|---|---|---|---|
| Location 1 | 1 | 2.8 | 4 |
| Location 2 | 2 | 2.4 | 2 |
| Location 3 | 3 | 2.2 | 1 |

The quantile labeling module 402 may store the scores of the sub-variables and the aggregate variable scores of the variables in the internal database 216 and/or provide the aggregate variable scores of the variables to the location index module 404.

The location index module 404 may generate a location recommendation for the job. The location recommendation may include a location index for each of the multiple locations available for the job. The location index may identify a proposed recommendation for each of the multiple locations. Therefore, with the location recommendation, the entity may select an optimal location among the multiple locations for the job. The optimal location may include a location with the highest location index among the other locations.

For computing the location index for each of the multiple locations, the location index module 404 may identify a respective weight of each variable. The respective weight of each variable may include a default weight, which may be defined based on importance of an overall computation of the location index. In some other examples, the respective weight of each variable may be dynamically updated according to the location requirements received from the entity. For example, if the location requirements prioritize the cost and the capability over the capacity, respective weights of the cost and the capability may be updated as ‘2’ and ‘2’ and a weight of the capacity may be updated as ‘1’. Example weights of the cost, the capacity, and the capability may include 1, 2, and 2, respectively, when the location requirements have not been received from the entity. Once the respective weight for each variable is determined, the location index module 404 may compute a weighted average score for each variable with respect to each of the multiple locations. The weighted average score for each variable with respect to each of the multiple locations may be computed based on the respective aggregate variable score of each variable generated for each of the multiple locations (depicted in table 12) and the respective weight of each variable. For example, a weighted average score of a variable may be represented as:

Weighted average score of variable=weight*aggregate variable score

Example weighted average score computed for each variable with respect to each of the locations 1-3 is illustrated in a table 13.

TABLE 13
Weighted average score of variables

| Location | Cost | Capability | Capacity |
|---|---|---|---|
| Location 1 | 1.8 | 2.8 | 5.6 |
| Location 2 | 2.4 | 2.4 | 4.8 |
| Location 3 | 3.8 | 2.2 | 4.4 |

The location index module 404 may compute the location index for each of the multiple locations based on the respective weighted average score of each variable computed with respect to each of the multiple locations (depicted in table 13). The location index computed for the locations 1-3 is illustrated in an example table 14.

TABLE 14
Location Indices of locations

| Location | Location Index |
|---|---|
| Location 1 | 15.4 |
| Location 2 | 11.2 |
| Location 3 | 10.2 |

Based on the respective location index, the location index module 404 may assign a rank for each of the multiple locations. For example, a location with the highest index among the other locations may be assigned with the highest rank and a location with the lowest index among the other locations may be assigned with the lowest rank.

The sensitivity analysis module 406 may perform sensitivity analysis tests to assess how the respective weight of each variable influences the location index. The sensitivity analysis tests may include non-parametric permutations tests, which may generate a sensitive outcome by shifting the respective weight of each variable randomly. In an example, the respective weight of each variable may be shifted randomly between 1-3, thereby 504 total permutations may be performed to generate the sensitive outcome. The sensitive outcome may indicate a sensitivity average score for each variable, a sensitivity average location index, and a sensitivity average rank of each of the multiple locations. An example sensitivity outcome indicating the sensitivity average score of each variable, the sensitivity average location index, and the sensitivity average rank with respect to the location index and the rank (e.g., original location index and original rank) of each of the multiple locations is illustrated in a table 15.

TABLE 15
Sensitive outcome

| | Sensitivity | Sensitivity | Sensitivity | Sensitivity | | | |
|---|---|---|---|---|---|---|---|
| | Average | Average | Average | Average | Sensitivity | | |
| | Score: | Score: | Score: | Location | Average | Location | |
| Location | Cost | Capability | Capacity | Index | Rank | Index | Rank |
| Location | 1.8 | 4 | 2.8 | 17.2 | 1.10515873 | 15.4 | 1 |
| 1 | | | | | | | |
| Location | 2.4 | 2 | 2.4 | 13.6 | 2.587301587 | 11.2 | 2 |
| 2 | | | | | | | |
| Location | 3.8 | 1 | 2.2 | 14 | 2.307539683 | 10.2 | 3 |
| 3 | | | | | | | |

Based on the sensitive outcome, the sensitivity analysis module 406 may generate a final sensitivity average rank for each of the variables with respect to each of the multiple locations. The final sensitivity average rank may act as an additional variance, which may aid in driving the location index of each of the multiple locations positively or negatively. An example comparison between the final sensitivity average rank and the rank of each of the locations 1-3 with respect to modification of the weights of the variables is illustrated in a table 16.

TABLE 16
Comparison between the final sensitivity average rank
and the rank (e.g., original rank)

| | | Sensitivity | Less rigid weights of |
|---|---|---|---|
| Location | Rank | Average Rank | variables |
| Location 1 | 1 | 1.10515873 | Same |
| Location 2 | 2 | 2.587301587 | Slightly worse |
| Location 3 | 3 | 2.307539683 | Improved |

In some examples, the sensitivity analysis module 406 may enable the location index module 404 to reassign the rank for each of the locations based on the final sensitivity average rank.

The insights generation module 408 may generate insights about each of the variables for each of the multiple locations and about each of the multiple locations. The insights generation module 408 may categorize each variable, based upon the respective aggregate variable score and generate the insights based on the categorization of each variable. The insights may provide information about a competitor size, operational domains, and/or an impact within a local market. Example illustrations of the insights are depicted in FIGS. 6A, 6B, and 6C.

FIG. 6A depicts an example illustration 600A of providing location recommendations and insights for jobs, in accordance with implementations of the present disclosure.

For example, in one scenario, where the system 102 receives an input including jobs 602 along with the location requirements from a user of an entity through the user device 108 (depicted in FIG. 1). The system 102 may generate and display location recommendations 604 for the jobs 602 on a user interface of the user device 108. Generation of the location recommendations for the jobs is already described in detail in conjunction with FIGS. 3 and 4, thereby repeated description is omitted herein for sake of brevity. The location recommendations 604 may indicate the jobs 602 (received in the input), optimal locations 606 recommended for the jobs 602, and location indices 608 of the optimal locations 606. The optimal locations 606 recommended for the jobs 602 may include a location 1 (L1) and a location 3 (L3).

If the user selects one of the jobs 602, the system 102 may display a detailed view 610, a map view 612, and a supply and demand snapshot 614 for the selected job. The detailed view 610 may indicate top-k locations 616 (e.g., 5 locations L1, L2, L3, L4, and L5) for the job, location indices 618 of the top-k locations, and insights 620 for all the top-k locations 616. Therefore, the user may compare the top-k locations 616 between each other according to their location indices 618 and the insights 620 and select an optimal location for the selected job. The insights 620 may indicate the aggregate variable score of each of the variables such as the cost, the capacity, the capability, and the additional statistics (e.g., depicted as cost score, capacity score, capability score, add.attr. score, in FIG. 6A) with respect to each of the top-k locations 616. The insights 620 may aid in visualizing the optimal location for the job, thereby the insights 620 may assist the user in making decisions about expanding their enterprise operations to new locations. For example, if the user decides to increase their workforce by creating new jobs including testers or product managers, the insights 620 may aid the user in selecting the optimal locations for the new jobs by comparing the weighted average scores of the variables across all the recommend locations (e.g., top-k locations 616).

The map view 612 may illustrate the top-k locations 616 recommended for the selected job with circles representing the respective location indices 618. For example, as depicted in the map view 612, the locations L1-L5 included in the top-k locations 616 may belong to same or different geographical areas. For instance, the locations L1 and L3 may belong to a geographical area 1 (GA1), the locations L2 and L5 may belong to a geographical area 2 (GA2), and the location L5 may belong to a geographical area 3 (GA3).

The supply and demand snapshot 614 may allow the user to view a current demand-to-supply ration at each of the top-k locations 616 recommended for the selected job.

FIG. 6B depicts another example illustration 600B of providing location recommendations and insights for a selected job, in accordance with implementations of the present disclosure. For example, the system 102 receives an input indicating a job 622 (e.g., business analyst) selected for receiving a location recommendation 624. Upon receiving the input, the system 102 may generate the location recommendation 624 and a detailed view 626. The location recommendation 624 may indicate an optimal location (e.g., the most favorable location as a location 1 (L1)) for the job 622. The detailed view 626 may indicate top-k locations 628 (e.g., 5 locations the L1, a location 2 (L2), a location 3 (L3), a location L4 (L4), and a location (L5)) for the job 622, location indices 630 of the top-k locations 628, and insights 632 for all the top-k locations 628. The insights 632 may indicate a score of each of sub-variables such as talent wages, talent availability (e.g., depicted as “Talent Avail.” in FIG. 6B), a level of competition (e.g., depicted as “Level of Com.” in FIG. 6B), a skill proficiency (e.g., depicted as “Skill Profic.” in FIG. 6B), and a skill availability (e.g., depicted as “Skill Avail.” in FIG. 6B), computed with respect to each of the top-k locations 628. Therefore, the insights 632 may provide a location-wise comparison of all the sub-variables along with the location indices 630 for the top-k locations 628.

Along with the detailed view 626, the system 102 may provide a demand view 634, a skill view 636, and a hiring or recruiting pattern view 638. The demand view 634 may highlight the top-in demand roles within the job 622 and an average market salary for the highlighted top-in demand roles. In some examples, salaries may be provided for each of the top-k locations 628. The skill view 636 may provide top skills required for the job 622. Additionally, or alternatively, the skill view 636 may provide an option for the user to filter the skills by selecting any one of the top-k locations 628. The hiring or recruiting pattern view 638 may provide hiring patterns of aspirational, peer, and/or partner companies (e.g., companies C1-C6) for the job 622, by comparing demand data from past and present years.

FIG. 6C depicts an example illustration 600C of providing insights for a location selected for a job, in accordance with implementations of the present disclosure. For example, the system 102 may provide insights 642 for a location 644 selected by a user. The user may select the location by applying a location filter on multiple or top-k locations (illustrated in FIGS. 6A and 6B) recommended for a requested job. The insights 642 may provide a location score 646 and a criteria score 648. The location score 646 may indicate a location index of the location 644 and a rank of the location 644. The criteria score 648 may indicate an aggregate variable score of each of the variables considered for the location 644. In some examples, the criteria score 648 may be color coded, which may indicate whether the aggregate variable score is “most favorable,” or “moderate,” or “least favorable” for each of the respective variables.

The system 102 may also provide a location index view 650, a skill view 652, and a variable view 654 along with the insights 642. The location index view 650 may provide a respective location index score with respect to each type or category of the job, highlighting the most favorable talent availability at the location 644. The skill view 652 may indicate top skills available within a talent pool at the location 644. The variable view 654 may indicate scores of each of the sub-variables corresponding to each of the variables, computed for the location 644.

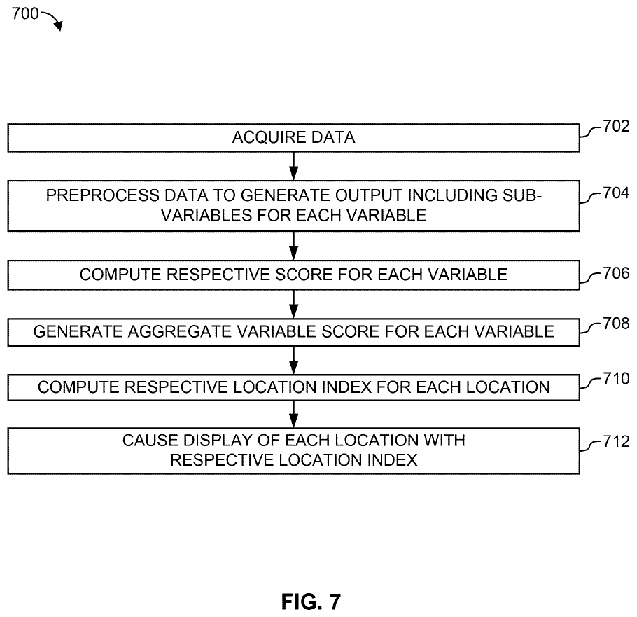

FIG. 7 is a flow diagram that presents an example computer implemented method 700 for generating the location recommendations for the jobs, in accordance with implementations of the present disclosure. In some implementations, the method 700 may be executed by the processor 202 (including the one or more processors), as described in relation to FIGS. 1-6.

The method 700 includes acquiring 702 data from the data sources 104a-104n (depicted in FIG. 1). In some examples, the data is related to an employment associated field.

The method 700 includes preprocessing 704 the data to generate an output. The output may include one or more sub-variables corresponding to each variable of the variables correspond with a job requirement. In some examples, the variables may include cost, capacity, and capability. Additionally, or alternatively, the variables may be supplemented with additional statistics. In some examples, the one or more sub-variables may include a talent wage, a corporate benefit liability, skill availability, skill proficiency, talent availability, corporate income tax, talent availability, and/or a level of competition.

In some examples, preprocessing the data to generate the output may include (i) selecting one or more roles and one or more skills relevant to the job requirement; (ii) computing an average salary for the job requirement for each location of the plurality of locations; (iii) aggregating job profiles for each location of the multiple locations to obtain the total talent availability; (iv) aggregating skill profiles for each location of the multiple locations to obtain the skill availability; and (v) generating a certification class category required for the job requirement. Generating the output including the one or more sub-variables of each variable is described in detail in conjunction with FIG. 3, therefore repeated description is omitted herein for sake of brevity.

Once the output is generated, the method 700 includes computing 706 a respective score for each sub-variable of the one or more sub-variables corresponding to each variable of the variables. The respective score for each sub-variable may be computed using a quantile-based discretization function, which is described in detail in conjunction with FIGS. 4 and 5.

Based upon a respective weight and the respective score for each sub-variable corresponding to each variable of the variables, the method 700 includes generating 708 an aggregate variable score for each variable of the multiple variables.

Based upon the aggregate variable score and a respective weight corresponding to the aggregate variable score for each variable of the variables, the method 700 includes computing 710 a respective location index for each location of the multiple locations for the job according to the job requirement. Computing the respective location index for each location is described in detail in conjunction with FIG. 4.

The method 700 includes causing 712 display of each location of the multiple locations for the job along with the respective location index. The respective location index may identify a proposed recommendation for each location of the plurality of locations, thereby generating a location recommendation for the job.

In some implementations, the method 700 includes categorizing each variable of the multiple variables to provide insights about each variable, based upon the aggregate variable score of each variable. In some examples, the insights may provide information about a competitor size, operational domains, and/or an impact within a local market. The method 700 includes causing display of the insights about each variable. Examples of the insights are illustrated in FIGS. 6A, 6B, and 6C.

In some implementations, the method 700 includes evaluating the respective weight of each variable using one or more sensitivity analysis tests. Based upon evaluation of the respective weight of each variable, the method 700 includes causing display of the insights about each location of the multiple locations for the job. Evaluation of the respective weight of each variable using the one or more sensitivity analysis tests is described in detail in conjunction with FIG. 3, therefore repeated description is omitted herein for sake of brevity.

Implementations of the present disclosure provide technical solutions to multiple technical problems that arise in the context of location recommendations for jobs. Implementation of the present disclosure provides a combination of quantitative and qualitative framework to generate the location recommendations for the jobs. The location recommendations may include location indices for locations available for the jobs and insights about variables and/or one or more sub-variables of each variable used to generate the location indices. The one or more sub-variables may be generated for each variable by preprocessing the data acquired from different data sources.

The data may be preprocessed using a DSPy prompt engineering framework in data bricks environment. Such a preprocessing of the data may improve functionality or performance of the system by accelerating processing speed, optimizing computing resource utilization, and providing an integrated environment for efficient feature engineering for talent feature classification tasks. For generating the location indices, each of the one or more sub-variables of each variable may be assigned with a respective score using quantile labeling, which may reduce computational complexity by considering only relevant data segments than processing the entire acquired data indiscriminately. In addition, implementations of the present disclosure utilize weight optimization using permutations, which may identify an optimal configuration including a default weight for each of the variables without exhaustive trial and error approaches. Such an approach may efficiently narrow down the default weights of the variables without the need for excessive data storage or manual intervention, which may reduce computation effort, time, storage and bandwidth requirements required to compute the location indices of the locations as well as improve accuracy and processing speed of computing the location indices of the locations.

Implementation of the present disclosure may generate the location recommendations for the jobs with the following further advantages:

Insights into Talent Acquisition: In addition to providing the location indices for the locations, implementations of the present disclosure may also provide insights about the variables. The insights may assist the entity on the top roles and essential skills for recruiting or sourcing the talent based on their specific operational functions and domain requirements. Therefore, providing the insights may ensure that the entity can establish operations with the right talent from the outset, optimizing efficiency and performance.

Industry/Domain-Specific Location Ranking: Implementations of the present disclosure may provide specialized location rankings tailored to different domains of the entity. For example, if the entity is interested in establishing a cybersecurity firm or expanding into the data and analytics sector, implementations of the present disclosure may identify the most suitable locations from the multiple locations and rank the most suitable locations based on their relevance to the domain that is of interest to the entity. Such a targeted approach may assist the entity in making informed decisions about where to grow their operations based on industry-specific criteria.

Competitor Analysis: Implementations of the present disclosure may also provide valuable insights into competitors present at the selected locations. Such an analysis encompasses competitor size, their operational domains, and their impact within a local market. By analyzing the competitive landscape, the entity may devise strategies to differentiate themselves, identify market gaps, and capitalize on opportunities effectively. Therefore, implementations of the present disclosure may not only assist the entity in location selection but also empowers the entity with the insights into talent acquisition, domain specific expansion strategies, and competitive positioning. Such an integrated approach may offer a comprehensive solution that addresses challenges faced during set up of offices or workspace by the entity for the jobs.

Comprehensive Feature Consideration: Implementations of the present disclosure may consider a wide array of features including capability, cost, capacity and additional attributes like talent wages, inflation rate, skill proficiency, role profiles, skill profiles, competitors profile, attrition rate, political risk, legal risk, cost of living, commute or travel time, stringency index, and/or the like. Such a comprehensive approach may ensure that the location index is based on an analysis of multiple factors that play important roles in location decision-making.

Customization and Flexibility: By integrating entity-defined weights to calculate the location index, in addition to the default weighting rule, implementations of the present disclosure may provide a high level of customization and flexibility that meets specific needs and priorities of the entity. The customization and flexibility may extend to the ability to add or remove features of interest, ensuring that the location index of the location remains relevant and adaptive to changing market conditions and requirements of the entity.

Speed and Efficiency: Implementations of the present disclosure may accelerate speed to value with the use of highly efficient skill proficiency models (e.g., LLMs) developed in the data bricks environment for preprocessing the acquired data. These models enhance computational efficiency and accuracy, allowing for faster and more reliable location readiness assessments.

Therefore, a combination of the comprehensive features, customization, flexibility, and speed may address the existing challenges that arise in the context of existing location recommendation systems, by delivering tailored, efficient, and accurate results.

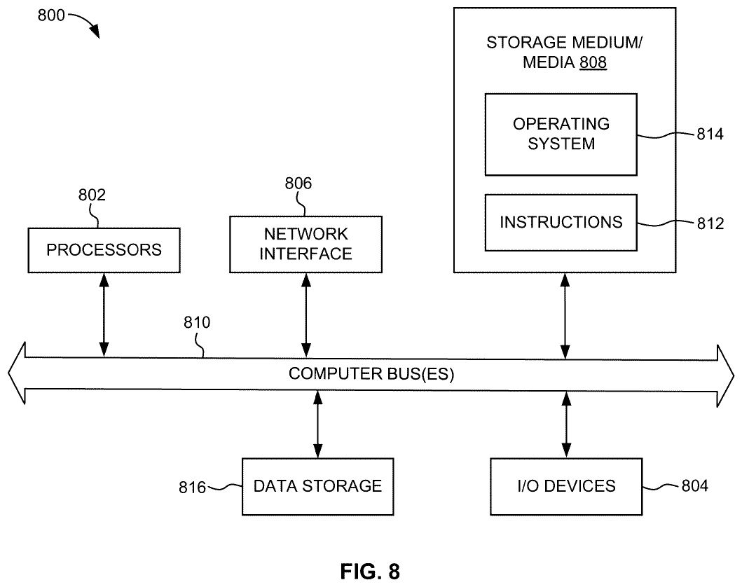

FIG. 8 depicts a computer system 800 that may be used to implement the system 102. More particularly, computing machines such as desktops, laptops, smartphones, tablets, and wearables which may be used to generate the location recommendations for the jobs. The computer system 800 may include additional components not shown and that some of the process components described may be removed and/or modified. In another example, the computer system 800 may be deployed on external-cloud platforms such as cloud, internal corporate cloud computing clusters, organizational computing resources, and/or the like.

The computer system 800 includes processor(s) 802 such as, a central processing unit, ASIC or another type of processing circuit, input/output devices 804 such as, a display, mouse keyboard, etc., a network interface 806 such as, a Local Area Network (LAN), a wireless 802.11x LAN, a 3G or 4G mobile WAN or a WiMax WAN, and a storage medium or media 808 (also be referenced to as computer-readable medium (CRM)). Each of these components may be operatively coupled to a bus 810. The computer-readable medium 808 may be any suitable medium that participates in providing instructions to the processor(s) 802 for execution. For example, the computer-readable medium 808 may be non-transitory or non-volatile medium such as, a magnetic disk or solid-state non-volatile memory or volatile medium such as RAM. The instructions or modules stored on the computer-readable medium 808 may include machine-readable instructions 812 executed by the processor(s) 802 that cause the processor(s) 802 to perform the methods and functions of the system 102.

The system 102 may be implemented as software stored on a non-transitory processor-readable medium and executed by the processor(s) 802. For example, the computer-readable medium 808 may store an operating system 814 such as, MAC OS, MS WINDOWS, UNIX, or LINUX, and code, for the system 102. The operating system 814 may be multi-user, multiprocessing, multitasking, multithreading, real-time, and the like. For example, during runtime, the operating system 814 is running and the code for the system 102 is executed by the processor(s) 802.

The computer system 800 may include a data storage 816, which may include non-volatile data storage. The data storage 816 stores any data used or generated by the system 102.

The network interface 806 connects the computer system 800 to internal systems for example, via a LAN. Also, the network interface 806 may connect the computer system 800 to the Internet. For example, the computer system 800 may connect to web browsers and other external applications and systems via the network interface 806.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer also includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 802 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A computer-implemented method for generating a location recommendation for a job, comprising:
acquiring data, by one or more processors, from a plurality of data sources,
wherein the acquired data includes employment data including the employment data fields corresponding to a job requirement, location data indicating a plurality of locations available within a geographical area according to the job requirement, and logistical considerations associated with the plurality of locations;
preprocessing, by the one or more processors, the acquired data to generate an output, the output comprising one or more sub-variables corresponding to each variable of a plurality of variables, each variable of the plurality of variables corresponds with the job requirement;
computing, by the one or more processors, a respective score for each sub-variable of the one or more sub-variables corresponding to each variable of the plurality of variables;
generating, by the one or more processors, based upon a respective weight and the respective score for each sub-variable corresponding to each variable of the plurality of variables, an aggregate variable score for each variable of the plurality of variables;
computing, by the one or more processors, based upon the aggregate variable score and a respective weight corresponding to the aggregate variable score for each variable of the plurality of variables, a respective location index for each location of the plurality of locations for the job according to the job requirement;
evaluating, using one or more sensitivity analysis tests by the one or more processors, the respective weight for each variable of the plurality of variables by dynamically updating the respective weight of each variable according to the job requirement; and
causing, by the one or more processors, based upon evaluation of the respective weight for each variable of the plurality of variables, display of location recommendations for the job along with the respective location index on a user interface, wherein the location recommendations include optimal locations recommended for the job,
wherein the display includes:
a detailed view that indicates top-k locations of the optimal locations for the job, the respective location index for each location of the top-k locations, and insights for all the top-k locations, and
a map view that shows the top-k locations with circles representing the respective location index, wherein the top-k locations belong to same or different geographical area.

2. The computer-implemented method of claim 1 further comprising:
categorizing, based upon the respective aggregate variable score for each variable of the plurality of variables, each variable to provide insights about each sub-variable, wherein the insights provide information about a competitor size, operational domains, and/or an impact within a local market; and
causing display of the insights about each variable of the plurality of variables.

3. The computer-implemented method of claim 1 further comprising:
causing display of insights, based upon evaluation of the respective weight for each variable of the plurality of variables, about each location of the plurality of locations for the job, wherein the insights provide information about a competitor size, operational domains, and/or an impact within a local market.

4. The computer-implemented method of claim 1, wherein the plurality of variables comprises cost, capacity, and capability.

5. The computer-implemented method of claim 1, wherein one or more sub-variables corresponding to a variable of the plurality of variables comprises a talent wage, a corporate benefit liability, skill availability, skill proficiency, talent availability, corporate income tax bracket, talent availability, and/or a level of competition.

6. The computer-implemented method of claim 1, wherein preprocessing the data comprises:
selecting one or more roles and one or more skills relevant to the job requirement;
computing an average salary for the job requirement for each location of the plurality of locations;
aggregating a plurality of job profiles for each location of the plurality of locations to obtain a total talent availability;
aggregating a plurality of skill profiles for each location of the plurality of locations to obtain a skill availability; and
generating a certification class category required for the job requirement.

7. The computer-implemented method of claim 1, wherein computing the respective score for each sub-variable of the one or more sub-variables corresponding to each variable of the plurality of variables comprises computing the respective score for each sub-variable of the one or more sub-variables corresponding to each variable of the plurality of variables using a quantile-based discretization function.

8. A system for generating a location recommendation for a job, comprising:
at least one memory comprising machine executable instructions; and
at least one processor communicatively coupled with the at least one memory, and configured to execute the machine executable instructions to perform operations comprising:
acquiring data from a plurality of data sources,
wherein the acquired data includes employment data including the employment data fields corresponding to a job requirement, location data indicating a plurality of locations available within a geographical area according to the job requirement, and logistical considerations associated with the plurality of locations;
preprocessing the acquired data to generate an output, the output comprising one or more sub-variables corresponding to each variable of a plurality of variables, each variable of the plurality of variables corresponds with the job requirement;
computing a respective score for each sub-variable of the one or more sub-variables corresponding to each variable of the plurality of variables;
generating, based upon a respective weight and the respective score for each sub-variable corresponding to each variable of the plurality of variables, an aggregate variable score for each variable of the plurality of variables;
computing, based upon the aggregate variable score and a respective weight corresponding to the aggregate variable score for each variable of the plurality of variables, a respective location index for each location of the plurality of locations for the job according to the job requirement;
evaluating, using one or more sensitivity analysis tests, the respective weight for each variable of the plurality of variables by dynamically updating the respective weight of each variable according to the job requirement; and
causing, based upon evaluation of the respective weight for each variable of the plurality of variables, display of location recommendations for the job along with the respective location index on a user interface, wherein the location recommendations include optimal locations recommended for the job,
wherein the display includes:
a detailed view that indicates top-k locations of the optimal locations for the job, the respective location index for each location of the top-k locations, and insights for all the top-k locations, and
a map view that shows the top-k locations with circles representing the respective location index, wherein the top-k locations belong to same or different geographical area.

9. The system of claim 8, wherein the operations further comprise:
categorizing, based upon the respective aggregate variable score for each variable of the plurality of variables, each variable of the plurality of variables to provide insights about each variable, wherein the insights provide information about a competitor size, operational domains, and/or an impact within a local market; and
causing display of the insights about each variable of the plurality of variables.

10. The system of claim 8, wherein the operations further comprise:
causing display of insights, based upon evaluation of the respective weight corresponding to the aggregate variable score for each variable of the plurality of variables, about each location of the plurality of locations for the job, wherein the insights provide information about a competitor size, operational domains, and/or an impact within a local market.

11. The system of claim 8, wherein the plurality of variables comprises cost, capacity, and capability.

12. The system of claim 8, wherein one or more sub-variables corresponding to a variable of the plurality of variables comprises a talent wage, a corporate benefit liability, skill availability, skill proficiency, talent availability, corporate income tax bracket, talent availability, and/or a level of competition.

13. The system of claim 8, wherein preprocessing the data comprises:
selecting one or more roles and one or more skills relevant to the job requirement;
computing an average salary for the job requirement for each location of the plurality of locations;
aggregating a plurality of job profiles for each location of the plurality of locations to obtain a total talent availability;
aggregating a plurality of skill profiles for each location of the plurality of locations to obtain a skill availability; and
generating a certification class category required for the job requirement.

14. The system of claim 8, wherein computing the respective score for each sub-variable of the one or more sub-variables corresponding to each variable of the plurality of variables comprises computing the respective score for each sub-variable of the one or more sub-variables corresponding to each variable of the plurality of variables using a quantile-based discretization function.

15. A non-transitory computer-readable medium (CRM) comprising machine executable instructions stored thereon, which, when executed by at least one processor of a computing device, cause the at computing device to perform operations for generating a location recommendation for a job, comprising:
acquiring data from a plurality of data sources,
wherein the acquired data includes employment data including the employment data fields corresponding to a job requirement, location data indicating a plurality of locations available within a geographical area according to the job requirement, and logistical considerations associated with the plurality of locations;
preprocessing the data to generate an output, the output comprising one or more sub-variables corresponding to each variable of a plurality of variables, each variable of the plurality of variables corresponds with the job requirement;
computing a respective score for each sub-variable of the one or more sub-variables corresponding to each variable of the plurality of variables;
generating, based upon a respective weight and the respective score for each sub-variable corresponding to each variable of the plurality of variables, an aggregate variable score for each variable of the plurality of variables;
computing, based upon the aggregate variable score and a respective weight corresponding to the aggregate variable score for each variable of the plurality of variables, a respective location index for each location of the plurality of locations for the job according to the job requirement;
evaluating, using one or more sensitivity analysis tests, the respective weight for each variable of the plurality of variables by dynamically updating the respective weight of each variable according to the job requirement; and
causing, based upon evaluation of the respective weight for each variable of the plurality of variables, display of location recommendations for the job along with the respective location index on a user interface, wherein the location recommendations include optimal locations recommended for the job,
wherein the display includes:
a detailed view that indicates top-k locations of the optimal locations for the job, the respective location index for each location of the top-k locations, and insights for all the top-k locations, and
a map view that shows the top-k locations with circles representing the respective location index, wherein the top-k locations belong to same or different geographical area.

16. The non-transitory CRM of claim 15, wherein the operations further comprise:
categorizing, based upon the respective aggregate variable score for each variable of the plurality of variables, each variable of the plurality of variables to provide insights about each variable, wherein the insights provide information about a competitor size, operational domains, and/or an impact within a local market; and
causing display of the insights about each variable of the plurality of variables.

17. The non-transitory CRM of claim 15, wherein the operations further comprise:
causing display of insights, based upon evaluation of the respective weight corresponding to the aggregate variable score for each variable of the plurality of variables, about each location of the plurality of locations for the job, wherein the insights provide information about a competitor size, operational domains, and/or an impact within a local market.

18. The non-transitory CRM of claim 15, wherein the plurality of variables comprises cost, capacity, and capability, and wherein one or more sub-variables corresponding to a variable of the plurality of variables comprises a talent wage, a corporate benefit liability, skill availability, skill proficiency, talent availability, corporate income tax bracket, talent availability, and/or a level of competition.

19. The non-transitory CRM of claim 15, wherein preprocessing the data comprises:
selecting one or more roles and one or more skills relevant to the job requirement; computing an average salary for the job requirement for each location of the plurality of locations;
aggregating a plurality of job profiles for each location of the plurality of locations to obtain a total talent availability;
aggregating a plurality of skill profiles for each location of the plurality of locations to obtain a skill availability; and
generating a certification class category required for the job requirement.

20. The non-transitory CRM of claim 15, wherein computing the respective score for each sub-variable of the one or more sub-variables corresponding to each variable of the plurality of variables comprises computing the respective score for each sub-variable of the one or more sub-variables corresponding to each variable of the plurality of variables using a quantile-based discretization function.
